(19) United States
(12) Patent Application Publication
(10) Pub. No.: US 2016/0114765 A1
(43) Pub. Date: Apr. 28, 2016

(54) WIPER ASSEMBLY AND WIPER DEVICE

(71) Applicant: DONGGUAN HONGYI WIPER CO., LTD., Dong Guan City (CN)

(72) Inventor: YUAN-CHIN KU, NEW TAIPEI CITY (TW)

(21) Appl. No.: 14/730,121

(22) Filed: Jun. 3, 2015

Related U.S. Application Data
(60) Provisional application No. 62/068,044, filed on Oct. 24, 2014.

(51) Int. Cl. B60S 1/38

(52) U.S. Cl. CPC B60S 1/38; B60S 2001/3839

(57) ABSTRACT

A wiper assembly includes at least two wiper strips each having a fixing portion and a wiping portion. The two wiper strips are arranged in parallel. Adjacent faces of the fixing portions of the wiper strips are respectively defined as a first joining face and a second joining face. The first joining face and the second joining face are attached to each other, such that the two wiper strips are joined together. A fastening portion can be disposed on the first joining face, a second fastening portion can be disposed on the second joining face. The first fastening portion and the second fastening portion engage each other. Thereby, the wiper assembly does not require other methods for joining and can maintain a preferred elasticity of the wiper strips, such that the wiper has a good fit.

### BACKGROUND OF THE INVENTION

1. Field of the Invention

The present disclosure relates to a wiper assembly and a wiper device; in particular, to a wiper assembly and a wiper device for wiping windshields and having a good fit.

2. Description of Related Art

Windshield wipers are mainly assembled on windshields of cars for wiping off rain or mud attached thereon, so that the rain or mud does not block the driver's line of sight. Conventional wipers have one wiper strip mounted on a wiper arm through a fitting, such that the wiper arm can drive the wiper to wipe off the rain or mud attached onto the windshield.

Some conventional wipers already uses two wiper strips to increase their ability to wipe off rain or mud. However, the two wiper strips of a conventional wiper need to be joined by a plastic unit which is an elongated frame or casing, such that the elasticity of the wiper strips are limited and the fit of the wipers is compromised, wherein the ends of the wipers are not in contact with the windshield, thereby reducing the effectiveness of wiping rain or mud.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a wiper assembly and a wiper device wherein the wiper assembly does not require other methods (components) for joining and can provide a preferred elasticity, such that the wiper has a good fit, and the ends of the wiper are in contact with the windshield for effectively wiping rain or mud therefrom.

In order to achieve the aforementioned objects, the present disclosure provides a wiper assembly comprising at least two wiper strips each having a fixing portion and a wiping portion. An upper edge of each of the wiper portions is connected to a lower edge of the respective fixing portion. The wiper strips are arranged parallel to each other, and the faces of the fixing portions thereof that are adjacent to each other are respectively defined as a first joining face and a second joining face. The first joining face and the second joining face are joined to each other, such that the two wiper strips are joined together.

Preferably, an elastic plate is disposed in each of the fixing portions, and the elastic plate extends along the length-wise direction of the wiper strip.

Preferably, a first fastening portion is arranged on the first joining face, and a second fastening portion is arranged on the second joining face. The first fastening portion and the second fastening portion engage each other.

In order to achieve the aforementioned objects, the present disclosure further provides a wiper device comprising: a wiper assembly; a wiper connector; a rigid frame; and a flexible carrier. The rigid frame is disposed on the flexible carrier. The wiper connector is connected to the rigid frame. The wiper assembly is assembled with the flexible carrier.

In order to achieve the aforementioned objects, the present disclosure further provides a wiper device comprising: a wiper assembly; a wiper connector; two first blades respectively pivotally connected to two ends of the wiper connector; and a plurality of second blades respectively connected to two ends of the two first blades. The wiper assembly is fixed to two ends of the second blades.

The present disclosure has the following advantages. The wiper assembly of the present disclosure has at least two wiper strips arranged parallel and adjacent to each other, wherein adjacent faces of the fixing portions thereof are defined as a first joining face and a second joining face and the first joining face and the second joining face are attached to each other, such that the two wiper strips are joined together without using other methods (components).

The first joining face and the second joining face are respectively formed with a first fastening portion and a second fastening portion. The first fastening portion and the second fastening portion engage each other, such that the two wiper strips are joined together without using other methods (components).

The wiper assembly of the present disclosure does not require other methods (components) for fastening, therefore maintaining the flexibility of the wiper strips, such that the wiper has a good fit, the ends thereof are in contact with the windshield, increasing the effectiveness of wiping off rain or mud.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a perspective view of a wiper assembly according to a first embodiment of the present disclosure;

FIG. 2 shows a perspective view from another angle of a wiper assembly according to a first embodiment of the present disclosure;

FIG. 3 shows a planar view of a wiper assembly according to a first embodiment of the present disclosure;

FIG. 4 shows an exploded view of a wiper device according to a second embodiment of the present disclosure;

FIG. 5 shows an exploded view from another angle of a wiper device according to a second embodiment of the present disclosure;

FIG. 6 shows a perspective view of a wiper device according to a second embodiment of the present disclosure;

FIG. 7 shows a perspective view of a wiper device from another angle according to a second embodiment of the present disclosure;

FIG. 8 shows a planar view of a wiper assembly according to a third embodiment of the present disclosure;

FIG. 9 shows a planar view of a wiper assembly according to a fourth embodiment of the present disclosure;

FIG. 10 shows a perspective view of a wiper assembly according to a fifth embodiment of the present disclosure;

FIG. 11 shows a planar view of a wiper assembly according to a sixth embodiment of the present disclosure;

FIG. 12 shows a planar view of a wiper assembly according to a seventh embodiment of the present disclosure;

FIG. 13 shows a planar view of a wiper assembly according to an eighth embodiment of the present disclosure;

FIG. 14 shows a perspective view of a wiper device according to a ninth embodiment of the present disclosure;

FIG. 15 shows a planar view of a wiper device according to a ninth embodiment of the present disclosure;

FIG. 16 shows a perspective view of a wiper device according to a tenth embodiment of the present disclosure;

FIG. 17 shows a perspective view of a wiper assembly according to an eleventh embodiment of the present disclosure; and

FIG. 18 shows an exploded view of a wiper device according to a twelfth embodiment of the present disclosure.

### DETAILED DESCRIPTION OF THE PREFERRED EMBODIMENTS

The present disclosure provides a wiper assembly and a wiper device, driven by a wiper arm such that the wiper contacts a windshield of a car. Additionally, the wiper arm drives the wiper to wipe off rain and mud from the windshield in a repeated motion.

### First Embodiment

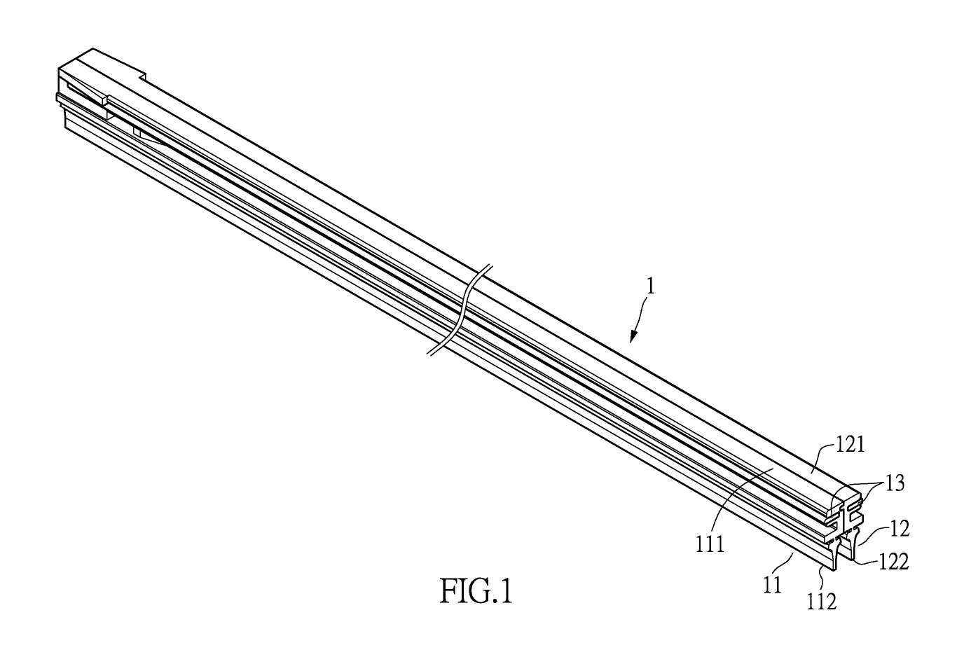

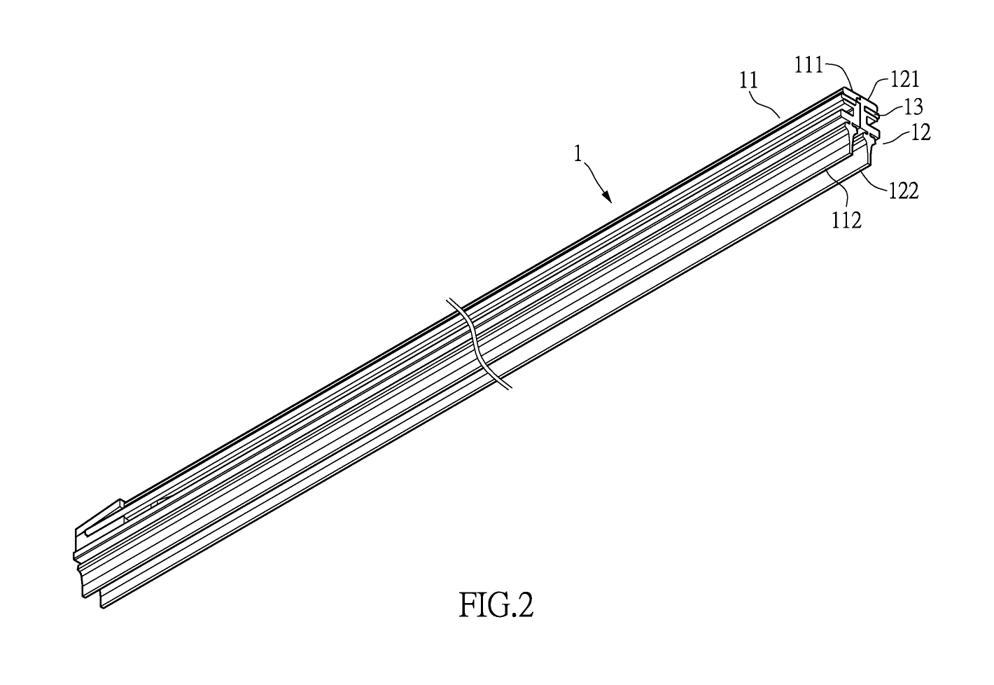

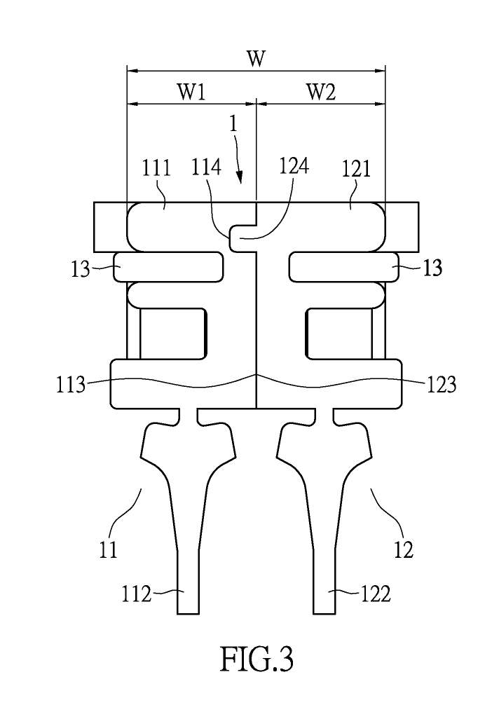

Referring to FIG. 1 to FIG. 3, the wiper assembly 1 of the present disclosure includes at least two wiper strips. The present embodiment discloses two wiper strips 11, 12, respectively a first wiper strip 11 and a second wiper strip 12. However, the quantity of wiper strips is not limited, and can be for example three or four.

The first wiper strip 11 and the second wiper strip 12 are each an elongated rubber unit. An upper portion of the first wiper strip 11 is formed with a fixing portion 111, and a lower portion of the first wiper strip 11 is formed with a wiping portion 112. An upper edge of the wiping portion 112 is connected to a lower edge of the fixing portion 111. An upper portion of the second wiper strip 12 is formed with a fixing portion 121, and a lower portion of the second wiper strip 12 is formed with a wiping portion 122. An upper edge of the wiping portion 122 is connected to a lower edge of the fixing portion 121. The wiping portions 112, 122 are substantially triangular. However, the shapes of the fixing portions 111, 121 and the shapes of the wiping portions 112, 122 are not limited, and can be modified as conventional wiper strips are. Additionally, an elastic plate 13 can be disposed in each of the fixing portions 111, 121. Each of the elastic plates 13 extends along a length-wise direction of the first wiper strip 11 and the second wiper strip 12. The elastic plate 13 increases the resilience of the first wiper strip 11 and the second wiper strip 12. One side of the elastic plate 13 can protrude from a side of the fixing portion 111, 121 of the first wiper strip 11 or the second wiper strip 12.

The first wiper strip 11 and the second wiper strip 12 are arranged in parallel. Adjacent faces of the fixing portion 111 of the first wiper strip 11 and the fixing portion 121 of the second wiper strip 12 can be joined to each other, such that the first wiper strip 11 and the second wiper strip 12 can be joined together. Specifically, the adjacent faces of the fixing portion 111 of the first wiper strip 11 and the fixing portion 121 of the second wiper strip 12 are respectively defined as a first joining face 113 and a second joining face 123. The first joining face 113 and the second joining face 123 are joined together, such that the first wiper strip 11 and the second wiper strip 12 are joined together.

The first joining face 113 and the second joining face 123 are preferably but not limited to being planar faces. For example, they can be curved faces with corresponding contours, e.g. the first joining face 113 can be a concave face or a convex face, and the second joining face 123 can be a convex face or a concave face, likewise being able to join to each other. The first joining face 113 and the second joining face 123 can be fixed by adhesives.

A first fastening portion 114 can be disposed on the first joining face 113 of the first wiper 11. A second fastening portion 124 can be disposed on the second joining face 123 of the second wiper strip 12. The first fastening portion 114 and the second fastening portions 124 are corresponding fastening structures configured to engage each other, such that the first wiper strip 11 and the second wiper strip 12 are joined together. The first fastening portion 114 can be a recessed portion, a protruding portion, or a partially recessed and partially protruding portion. The second fastening portion 124 can likewise be a recessed portion, a protruding portion, or a partially recessed and partially protruding portion. The first fastening portions 114 can be disposed continuously or with spacing therebetween, but is not limited thereto. The second fastening portions 124 can be disposed continuously or with spacing therebetween, but is not limited thereto.

The position of the first fastening portion 114 on the first joining face 113 is not limited, and can be proximal to an upper edge, a lower edge, or the center of the fixing portion 111. The position of the second fastening portion 124 on the second joining face 123 is not limited, and can be proximal to an upper edge, a lower edge, or the center of the fixing portion 121. Namely, the first fastening portion 114 and the second fastening portion 124 can be arranged at any height of the first joining face 113 and the second joining face 123. In the present embodiment, the first fastening portion 114 and the second fastening portion 124 are proximal to the upper edges of the fixing portions 111, 112.

The present embodiment discloses a first fastening portion 114 and a second fastening portion 124 whose cross sections are rectangular, but the shapes of said cross sections are not limited thereto and can be circular, semi-circular, triangular, trapezoidal, etc. The present embodiment discloses a first fastening portion 114 which is an elongated recessed portion, and a second fastening portion 124 which is an elongated protruding portion. Namely, the first fastening portion 114 extends to two ends of the first wiper strip 11, and the second fastening portion 124 extends to two ends of the second wiper strip 12. The recessed portion and the protruding portion engage each other, such that the wiper strips 11, 12 are joined together, and achieve ideal fastening such that no other joining methods (components) are required.

A width W of a top portion of the wiper assembly 1 is greater than a width W1 of a top portion of the first wiper strip. The width W of the top portion of the wiper assembly 1 is likewise greater than a width W2 of a top portion of the second wiper strip 12.

### Second Embodiment

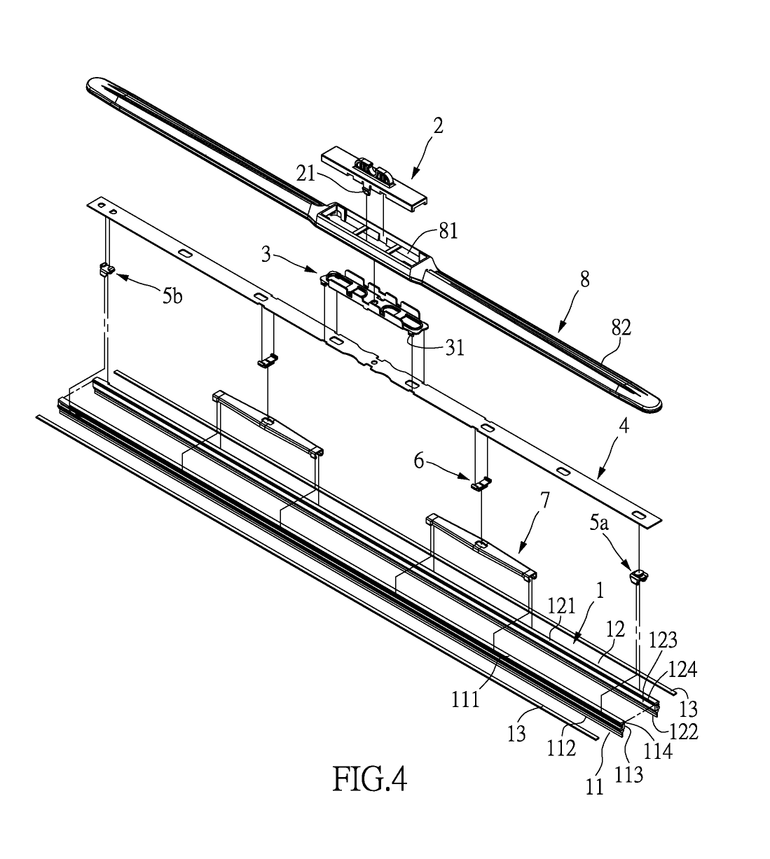

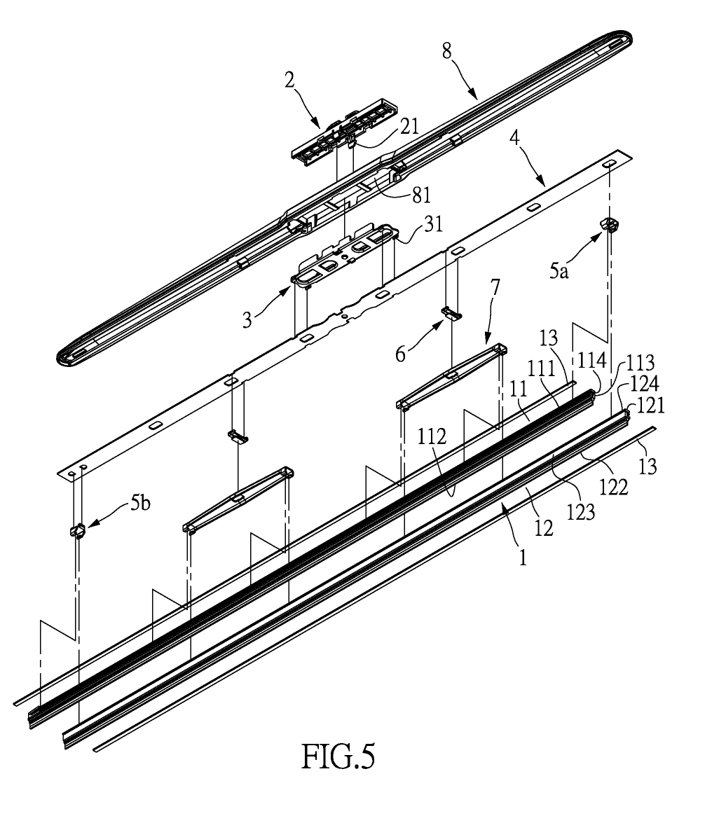

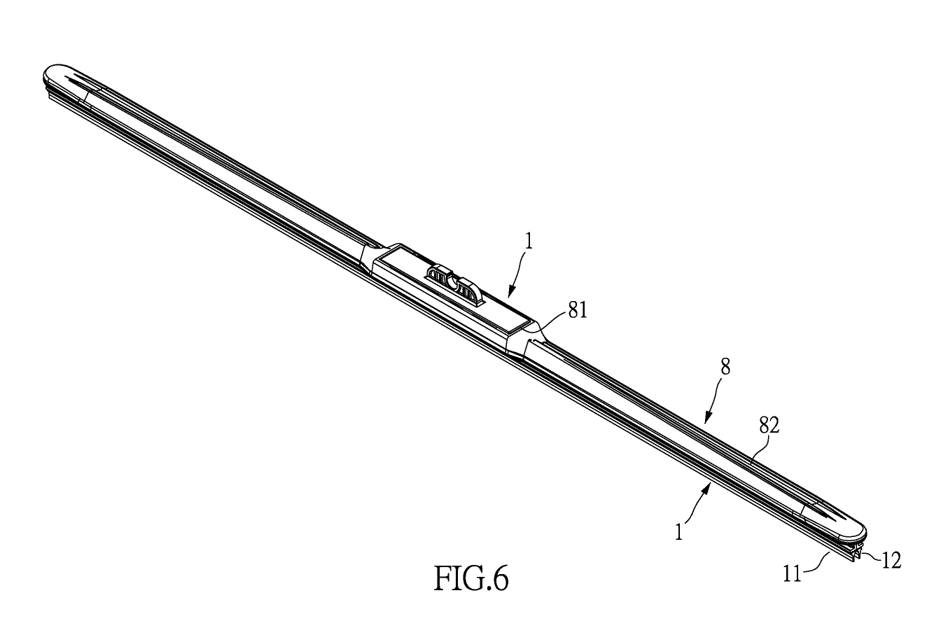

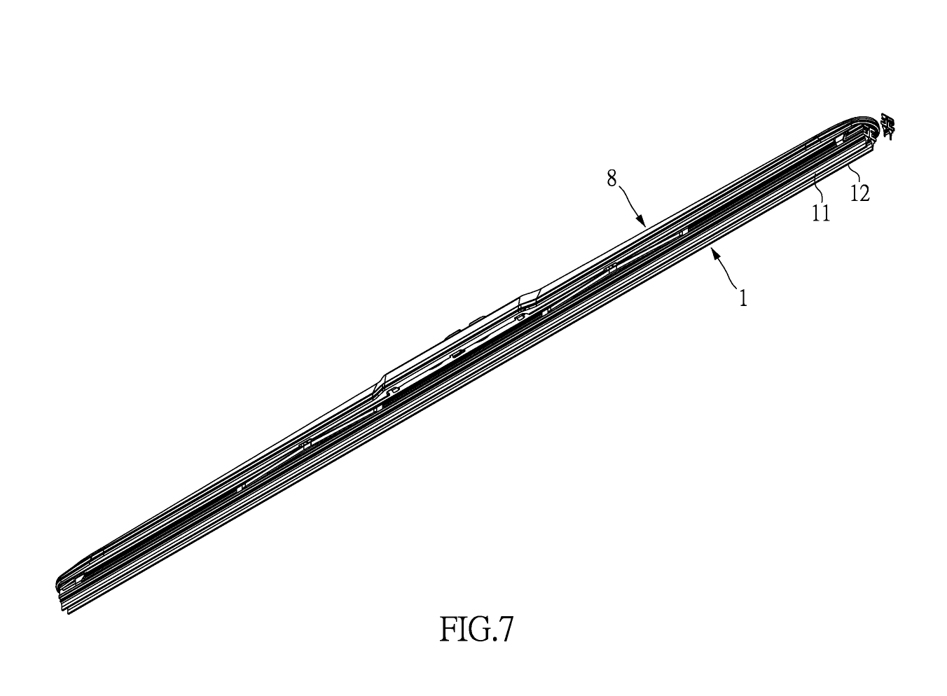

Referring to FIG. 4 to FIG. 7, the present disclosure provides a wiper device comprising a wiper assembly 1, a wiper connector 2, a rigid frame 3 and a flexible carrier 4. The rigid frame 3 can be fixedly disposed at the center of the flexible carrier 4. The rigid frame 3 is fixed to the flexible carrier 4 by a plurality of bent portions 31. The wiper connector 2 is connected to the rigid frame 3. Namely, the wiper connector 2 has two locking portions 21 extending downward. The locking portions 21 pass through and are locked into the rigid frame 3. The wiper assembly 1 is fixed to the flexible carrier 4. The method of fixing the wiper strip assembly 1 to the flexible carrier 4 is not limited and can be any of the existing methods of fixture.

The wiper device of the present embodiment further includes two first fixing units 5a, 5b, two second fixing units 6 and two blades 7. Two ends of the flexible carrier 4 and two ends of the wiper assembly 1 are fixed by the first fixing units 5a, 5b. The flexible carrier 4 is also fixed to the wiper assembly 1 by the two second fixing units 6 and the two blades 7, such that the wiper assembly 1 is fixed to the flexible carrier 4.

Specifically, upper portions of the first fixing units 5a, 5b are fixed to two ends of the flexible carrier 4, lower portions of the first fixing units 5a, 5b are fixed to the fixing portions 111 and the fixing portion 121 of the first wiper strip 11 and the second wiper strip 12. The second fixing units 6 and the blades 7 are fixed to each other. Upper portions of the second fixing units 6 are fixed to the flexible carrier 4. Two ends of each of the blades 7 are fixed to the fixing portion 111 and the fixing portion 121 of the first wiper strip 11 and the second wiper strip 12. The two first fixing units 5a, 5b and two ends of each of the blades 7 grasp outer sides of the fixing portion 111 and the fixing portion 121 of the first wiper strip 11 and the second wiper strip 12, such that the first wiper strip 11 and the second wiper strip 12 are securely held together. The two first fixing units 5a, 5b and two ends of each of the two blades 7 can also grasp outer sides of the two elastic plates 13, thereby pressing the first wiper strip 11 and the second wiper strip 12 together, thereby securely joining the same.

The present embodiment further includes a compression sleeve 8 sleeved on the flexible carrier 4. The compression sleeve 8 can surround the upper portion and part of the underside of the flexible carrier 4. The center of the compression sleeve 8 is formed with an opening 81, whereby the rigid frame 3 is exposed for connection to the wiper connector 2. The wiper device is installed on a car. When the car is moving, wind presses a sleeve wall 82 of the compression sleeve 8, such that the compression sleeve 8 presses the wiper toward the windshield of the car, increasing the fit of the wiper to the windshield.

### Third Embodiment

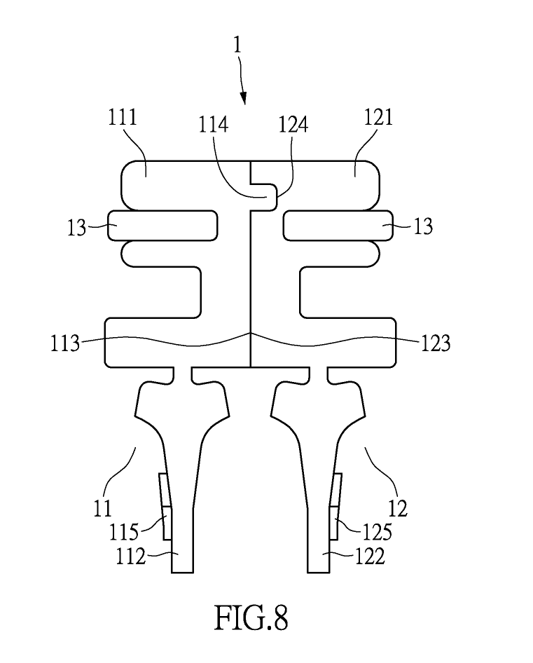

Referring to FIG. 8, the present embodiment discloses a first fastening portion 114 and a second fastening portion 124 proximal to upper edges of the fixing portions 111, 121. The first fastening portion 114 is an elongated protruding portion, the second fastening portion 124 is an elongated recessed portion, the protruding portion and the recessed portion engage such that the wiper strips 11, 12 are joined together, achieving preferred fastening without using other methods (components) for joining Additionally, a side of each of the wiping portions 112, 122 of the first wiper strip 11 and the second wiper strip 12 can be arranged with a plurality of protruding bodies 115, 125. The protruding bodies 115, 125 are arranged at intervals. Namely, the protruding bodies 115, 125 are arranged along a length-wise direction of the wiping portions 112, 122 with spacing therebetween. However, the shapes of the protruding bodies 115, 125 are not limited, and the length of the spacing therebetween is also not limited. In fact, the protruding bodies 115, 125 may be arranged without any spacing at all therebetween, such that they are actually connected and not arranged at intervals. The protruding bodies 115, 125 can be in tight contact with the windshield of a car, such that the wiper device can successfully wipe off bird feces or other sticky objects.

### Fourth Embodiment

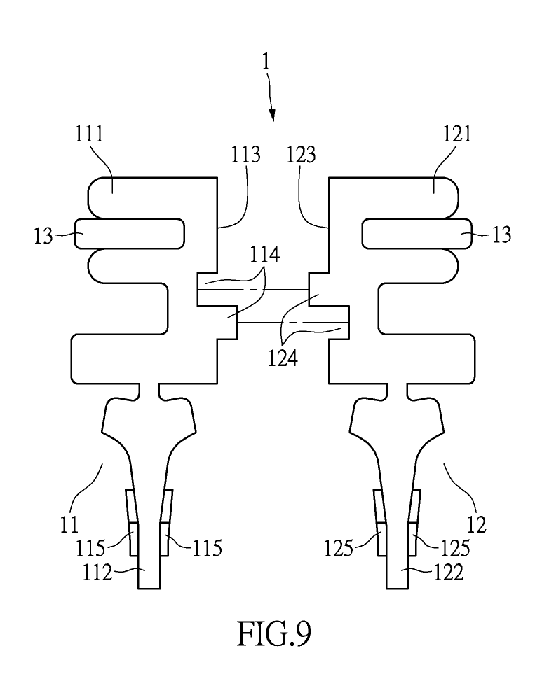

Referring to FIG. 9, the present embodiment discloses a first fastening portion 114 and a second fastening portion 124 proximal to the center of the fixing portions 111, 121. The first fastening portion 114 and the second fastening portion 124 are corresponding elongated recessed and protruding portions engaged to each other such that the wiper strips 11, 12 are joined together, and achieve ideal fastening such that no other joining methods (components) are required. Of course, the first fastening portion 114 can also be a plurality of column-shaped protruding portions, the second fastening portion 124 can also be a plurality of column-shaped recessed portions, and the protruding portions engage the recessed portions such that the wiper strips 11, 12 are joined together. The first fastening portion 114 and the second fastening portion 124 can also be square pillars or other shapes.

### Fifth Embodiment

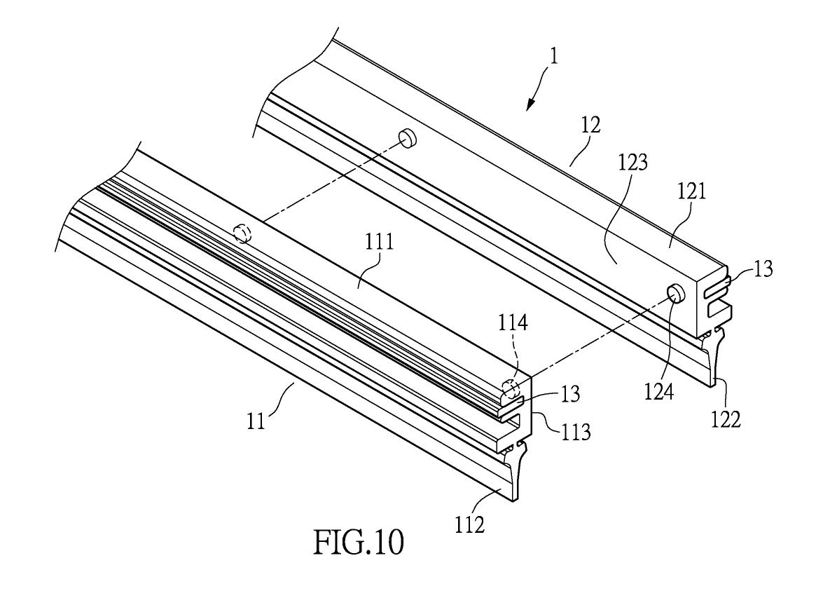

Refer to FIG. 10. In this embodiment, the first fastening portions 114 can be cylinder-shaped concaved portions, and the second fastening portion 124 can be cylinder-shaped convex portions. The concaved portions are matched with the convex portions and orientated to each other, so that the wiper strips 11, 12 are joined together, and achieve ideal fastening such that no other joining methods (components) are required. Of course, the first fastening portions 114 can be cylinder-shaped convex portions, and the second fastening portion 124 can be cylinder-shaped concaved portions. The concaved portions are matched with the convex portions and orientated to each other, so that the wiper strips 11, 12 are joined together. Further, the first fastening portions 114 and the second fastening portion 124 can be other shape, such as rectangular-prism shaped.

### Sixth and Seventh Embodiments

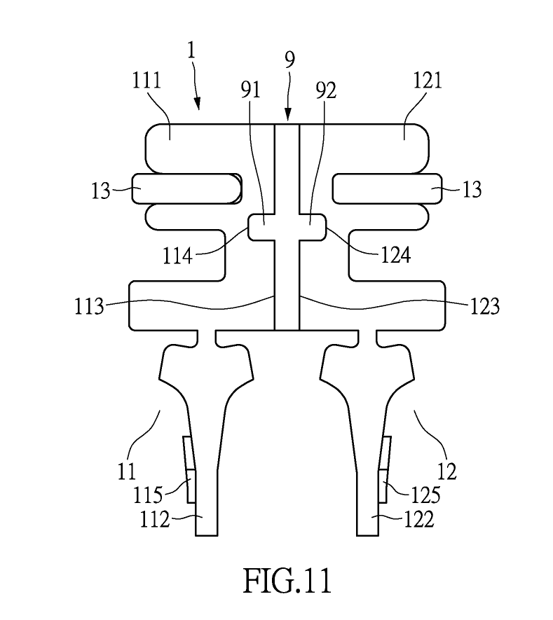

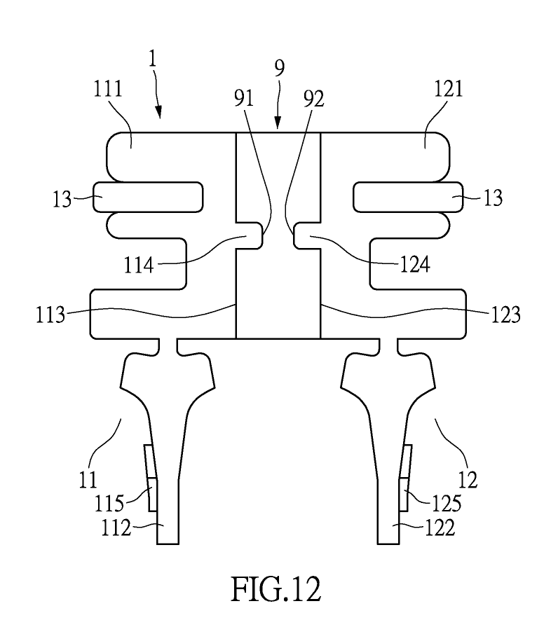

Referring to FIG. 11 and FIG. 12, the present two embodiments disclose an intermediate material 9 arranged between the first joining face 113 and the second joining face 123. The intermediate material 9 can be made of rubber or other materials having preferred elasticity. The first joining face 113 and the second joining face 123 are joined by the intermediate material 9, such that the first wiper strip 11 and the second wiper strip 12 are joined together. A first fastening portion 114 is disposed on the first joining face of the first wipers strip 11. A second fastening portion 124 is disposed on the second joining face 123 of the second wiper strip 12. Two faces of the intermediate material 9 can be respectively formed with a third fastening portion 91 and a fourth fastening portion 92. The first fastening portion 114 and the third fastening portion 91 are corresponding fastening structures and engage each other. The second fastening portion 124 and the fourth fastening portion 92 are corresponding fastening structures and engage each other. Thereby, the first wiper strip 11 and the second wiper strip 12 are joined together, and achieve ideal fastening such that no other joining methods (components) are required. The first joining face 113 and the second joining face 123 can be further fixed to the intermediate material 9 by adhesives.

### Eighth Embodiment

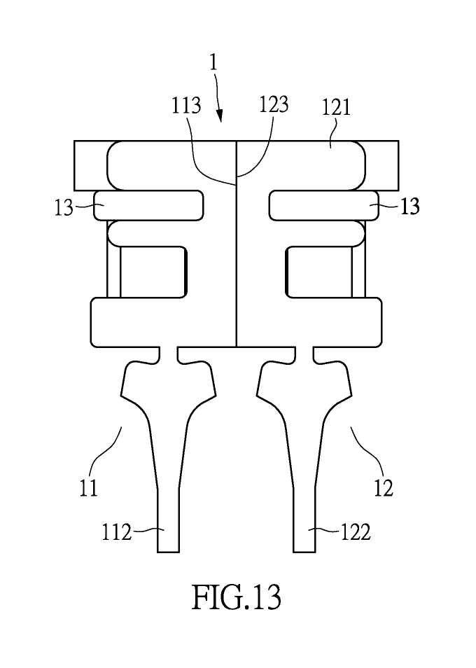

Referring to FIG. 13, the present embodiment omits the abovementioned first fastening portion 114 and second fastening portion 124. Adjacent faces of the fixing portion 111 of the first wiper strip 11 and the fixing portion 121 of the second wiper strip 12 are respectively defined as a first joining face 113 and a second joining face 123. The first joining face 113 and the second joining face 123 are sealed to each other such that the first wiper strip 11 and the second wiper strip 12 are joined together. In the present embodiment and the previous embodiments, the first joining face 113 and the second joining face 123 can be fixed to each other by adhesives, such as glue, double-sided tapes, and other adhesives.

### Ninth Embodiment

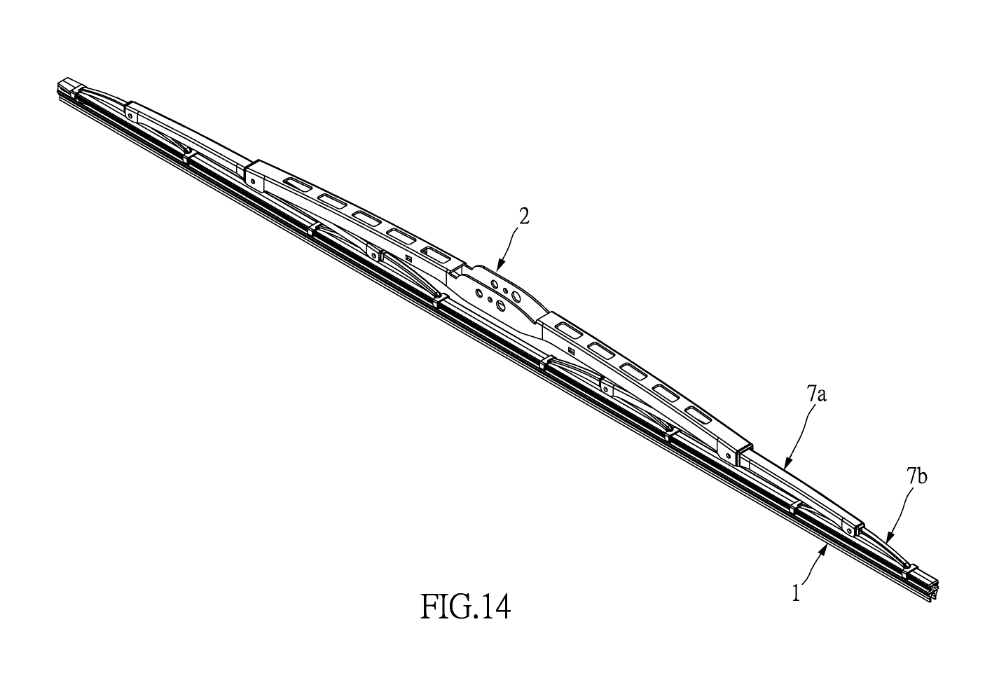

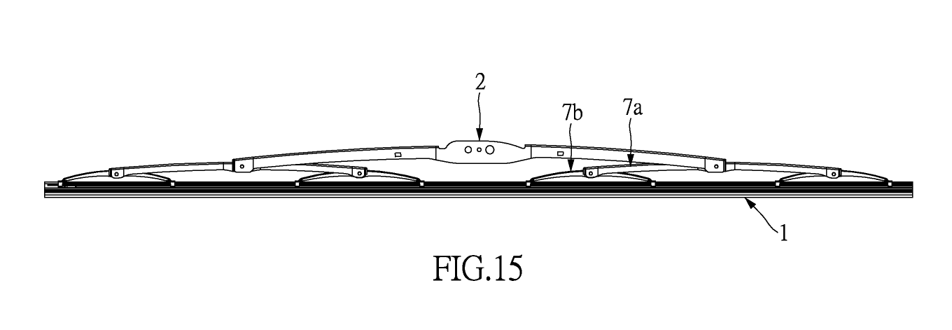

Referring to FIG. 14 and FIG. 15, the present embodiment discloses a wiper assembly 1 applied to another type of wiper device. Namely, the wiper assembly 1 of the present disclosure can be applied to different types of current wiper devices. In the present embodiment, the wiper device comprises a wiper assembly 1, a wiper connector 2, two first blades 7a, and a plurality of second blades 7b. The two first blades 7a are respectively pivotally connected to two ends of the wiper connector 2. The second blades 7b are respectively pivotally connected to two ends of the two first blades 7a. The wiper assembly 1 is fixed to two ends of the second blades 7b. Namely, two ends of the second blades 7b are fixed to the fixing portion 111 and the fixing portion 121 of the first wiper strip 11 and the second wiper strip 12 (please refer to FIG. 1 to FIG. 3). Two ends of the second blades 7b grasp outer sides of the fixing portion 111 and the fixing portion 121 of the first wiper strip 11 and the second wiper strip 12, such that the first wiper strip 11 and the second wiper strip 12 are securely joined together. Two ends of the second blades 7b can also grasp outer sides of the two elastic plates 13, such that the first wiper strip 11 and the second wiper strip 12 are securely joined together.

### Tenth, Eleventh, and Twelfth Embodiment

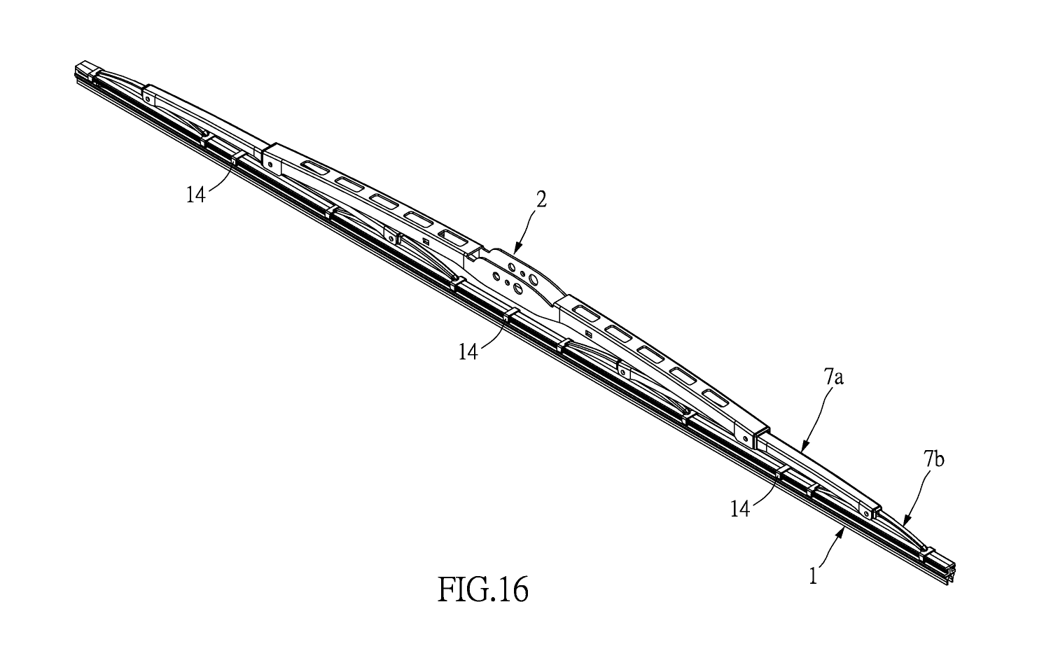

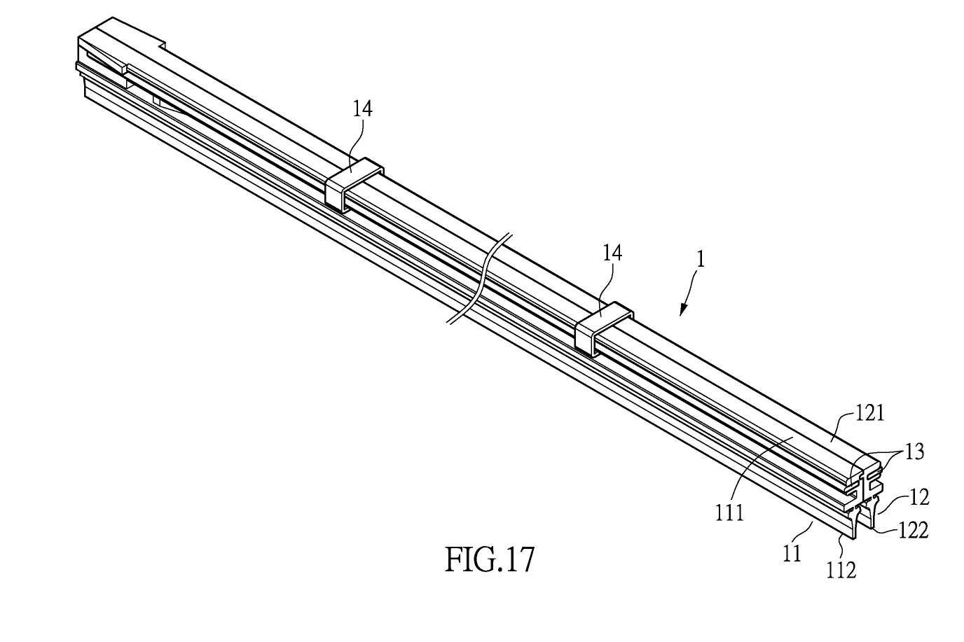

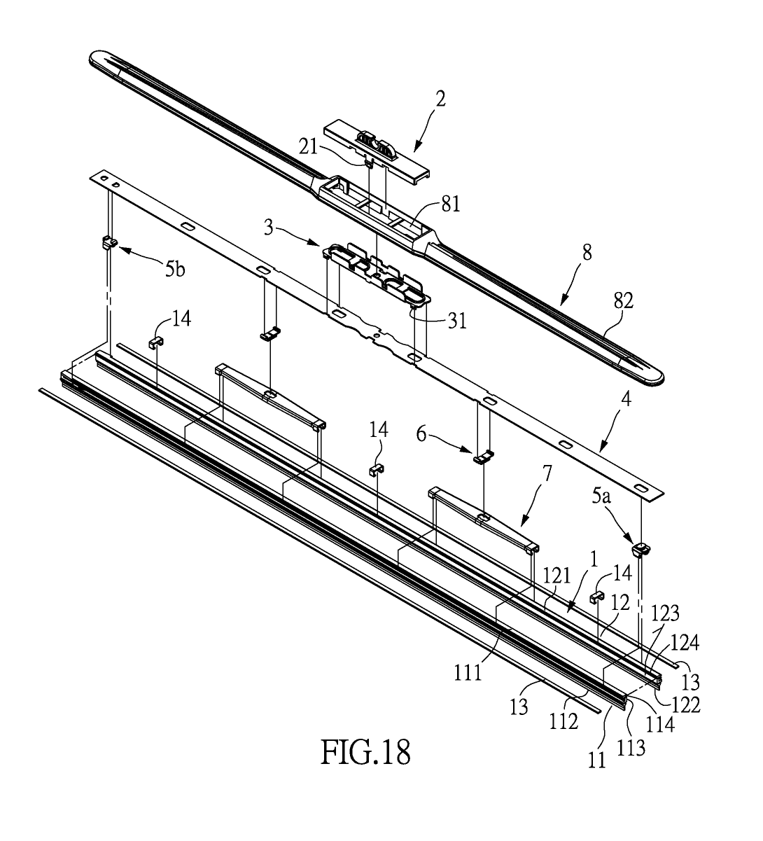

Referring to FIG. 16 to FIG. 18, the present embodiments disclose a clasp 14 disposed between the first wiper strip 11 and the second wiper strip 12. The clasp 14 can be made of metal (such as stainless steel or other material). The clasp 14 can grip the fixing portion 111 of the first wiper strip 11 and the fixing portion 121 of the second wiper strip 12, such that the first wiper strip 11 and the second wiper strip 12 are more securely joined together.

The wiper assembly and the wiper device of the present disclosure has the following advantages. The wiper assembly of the present disclosure includes at least two wiper strips arranged in parallel. Adjacent faces of the fixing portions of the two wiper strips are respectively defined as a first joining face and a second joining face. The first joining face and the second joining face are attached together, such that the two wiper strips are joined together without using other methods (components) for joining.

The wiper strips of the present disclosure are joined through attachment of the first joining face to the second joining face. The tight joining of the wiper strips and neat parallel arrangement of the wiper strips facilitates an evenly distributed contact between the wiper strips and the windshield, thereby achieving a preferred effect of wiping off rain and mud.

A first fastening portion and a second fastening portion are respectively disposed on the first joining face and the second joining face. The first fastening portion and the second fastening portion engage each other, such that the two wiper strips are joined together without using other methods (components) for joining.

The wiper strips of the present disclosure do not require other methods (components) for joining, thereby maintaining a preferred elasticity such that the wiper has a good fit and two ends thereof are in contact with the windshield increasing the effect of wiping off rain and mud.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A wiper assembly comprising: at least two wiper strips each having a fixing portion and a wiping portion, wherein an upper edge of each of the wiping portions is connected to a lower edge of the respective fixing portion, the two wiper strips are arranged in parallel, adjacent faces of the fixing portions of the two wiping strips are respectively defined as a first joining face and a second joining face, the first joining face and the second joining face are attached to each other, and the at least two wiper strips are joined together.

2. The wiper assembly according to claim 1, wherein an elastic plate is disposed in each of the fixing portions, and the elastic plates extend along a length-wise direction of the wiper strips.

3. The wiper assembly according to claim 1, wherein a first fastening portion is disposed on the first joining face, a second fastening portion is disposed on the second joining face, and the first fastening portion and the second fastening portion engage each other.

4. The wiper assembly according to claim 3, wherein the first fastening portion and the second fastening portion are a recessed portion, a protruding portion, or a partially recessed and partially protruding portion.

5. The wiper assembly according to claim 1, wherein a first fastening portion is disposed on the first joining face, a second fastening portion is disposed on the second joining face, an intermediate material is arranged between the first joining face and the second joining face, the first joining face and the second joining face are joined by the intermediate material, two faces of the intermediate material are respectively formed with a third fastening portion and a fourth fastening portion, the first fastening portion engages the third fastening portion, and the second fastening portion engages the fourth fastening portion.

6. The wiper assembly according to claim 1, wherein a width of a top portion of the wiper assembly is greater than a width of a top portion of each of the wiper strips.

7. The wiper assembly according to claim 1, wherein a plurality of protruding bodies are disposed at one side or two sides of each of the wiping portions of the two wiping strips, and the protruding bodies are arranged at intervals along a length-wise direction of the wiping portions.

8. The wiper assembly according to claim 1, wherein the first joining face and the second joining face are fixed to each other by adhesive.

9. The wiper assembly according to claim 1, further comprising a clasp configured to grip the fixing portions of the two wiper strips.

10. A wiper device comprising:
a wiper assembly, wherein the wiper assembly includes at least two wiper strips each having a fixing portion and a wiping portion, an upper edge of each of the wiping portions is connected to a lower edge of the respective fixing portion, the two wiper strips are arranged in parallel, adjacent faces of the fixing portions of the two wiping strips are respectively defined as a first joining face and a second joining face, the first joining face and the second joining face are attached to each other, and the at least two wiper strips are joined together;
a wiper connector;
a rigid frame; and
a flexible carrier; wherein
the rigid frame is disposed on the flexible carrier, the wiper connector is connected to the rigid frame, and the wiper assembly is fixed to the flexible carrier.

11. The wiper device according to claim 10, wherein an elastic plate is disposed in each of the fixing portions, and the elastic plates extend along a length-wise direction of the wiper strips.

12. The wiper device according to claim 10, wherein a first fastening portion is disposed on the first joining face, a second fastening portion is disposed on the second joining face, and the first fastening portion and the second fastening portion engage each other.

13. The wiper device according to claim 10, wherein a first fastening portion is disposed on the first joining face, a second fastening portion is disposed on the second joining face, an intermediate material is arranged between the first joining face and the second joining face, the first joining face and the second joining face are joined by the intermediate material, two faces of the intermediate material are respectively formed with a third fastening portion and a fourth fastening portion, the first fastening portion engages the third fastening portion, and the second fastening portion engages the fourth fastening portion.

14. The wiper device according to claim 10, wherein a plurality of protruding bodies are disposed at one side or two sides of each of the wiping portions of the two wiping strips, and the protruding bodies are arranged at intervals along a length-wise direction of the wiping portions.

15. The wiper device according to claim 10, further comprising a clasp configured to grip the fixing portions of the two wiper strips.

16. A wiper device comprising:
a wiper assembly, wherein the wiper assembly includes at least two wiper strips each having a fixing portion and a wiping portion, an upper edge of each of the wiping portions is connected to a lower edge of the respective fixing portion, the two wiper strips are arranged in parallel, adjacent faces of the fixing portions of the two wiping strips are respectively defined as a first joining face and a second joining face, the first joining face and the second joining face are attached to each other, and the at least two wiper strips are joined together;
a wiper connector;
two first blades respectively pivotally connected to two ends of the wiper connector; and
a plurality of second blades respectively pivotally connected to two ends of the first blades, wherein the wiper assembly is fixed to two ends of the plurality of second blades.

17. The wiper device according to claim 16, wherein an elastic plate is disposed in each of the fixing portions, and the elastic plates extend along a length-wise direction of the wiper strips.

18. The wiper device according to claim 16, wherein a first fastening portion is disposed on the first joining face, a second fastening portion is disposed on the second joining face, and the first fastening portion and the second fastening portion engage each other.

19. The wiper device according to claim 16, wherein a plurality of protruding bodies are disposed at one side or two sides of each of the wiping portions of the two wiping strips, and the protruding bodies are arranged at intervals along a length-wise direction of the wiping portions.

20. The wiper device according to claim 16, further comprising a clasp configured to grip the fixing portions of the two wiper strips.
